(19) United States
(12) Patent Application Publication
(10) Pub. No.: US 2026/0001583 A1
(43) Pub. Date: Jan. 1, 2026

(54) MULTI-USE PLATFORM

(71) Applicant: SWIMC, LLC, Cleveland, OH (US)

(72) Inventors: Sharad Gaurav, Cleveland, OH (US); Edward R. Goodwin, Westlake, OH (US); Michael C. Lambertson, Aurora, OH (US); Yandong Shen, Guandong PR (CN)

(21) Appl. No.: 19/138,094

(22) PCT Filed: Jul. 11, 2023
(86) PCT No.: PCT/US2023/027413

§ 371 Date: Jun. 11, 2025

Related U.S. Application Data
(60) Provisional application No. 63/388,058, filed on Jul. 11, 2022.

(51) Int. Cl. B62B 1/00; B25H 1/04; B25H 5/00; B62B 1/12; B62B 1/14; B62B 1/26; B62B 3/02; B62B 5/06; E04G 1/22; E04G 1/30; E04G 7/34

(52) U.S. Cl. CPC B62B 1/002; B25H 1/04; B25H 5/00; B62B 1/12; B62B 1/14; B62B 1/264; B62B 3/02; B62B 5/067; E04G 1/22; E04G 1/30; E04G 7/34; B62B 2203/60; B62B 2205/33; B62B 2206/006; E04G 2001/305

(57) ABSTRACT

Described herein is a multi-use platform that is capable of being manipulated into multiple configurations. Example configurations include a mechanic's creeper (first configuration), a pushcart (second configuration), a hand truck (third configuration), a work platform, e.g., scaffold (fourth configuration), and a work bench (fifth configuration).

### CROSS REFERENCE TO RELATED APPLICATIONS

This application claims the benefit under 35 U.S.C. § 119 of U.S. Provisional Application No. 63/388,058, filed Jul. 11, 2022. The contents of the aforementioned application are hereby incorporated by reference in its entirety.

### TECHNICAL FIELD

The present disclosure relates generally to a multi-use platform with multiple configurations, including but not limited to a workbench and a device for transporting supplies.

### BACKGROUND

In the construction industry, tradesmen frequently need several different items at a job site. A workbench may be desirable. Other items that might be needed are pushcarts and/or hand trucks for bringing supplies to the job site. There is usually limited space available in the vehicle employed for transporting supplies to a job site, including all of the aforementioned items.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a multi-use platform that is capable of being manipulated into multiple configurations. Example configurations include a mechanic's creeper (first configuration), a pushcart (second configuration), a hand truck (third configuration), a work platform, e.g., scaffold (fourth configuration), and a work bench (fifth configuration). In some embodiments, not all of the aforementioned configurations are included.

### BRIEF DESCRIPTION OF THE DRAWINGS

The accompanying drawings incorporated herein and forming a part of the specification illustrate the example embodiments.

FIG. 1 illustrates an example of a side view of a multi-use platform in a first configuration.

FIG. 2 illustrates an example of a top view of the multi-use platform in the first configuration.

FIG. 3 illustrates an example of a bottom view of the multi-use platform in the first configuration.

FIG. 4 illustrates an example side view of the multi-use platform in a second configuration.

FIG. 5 is a perspective view of the multi-use platform in the second configuration.

FIG. 6 is a perspective view illustrating an alternative embodiment of the multi-use platform in the second configuration.

FIG. 7 illustrates the multi-use platform in a third configuration.

FIG. 8 is a close up view illustrating an example of grips on the hand truck flap.

FIG. 9 is a perspective view illustrating the third configuration with a five gallon paint bucket surmounted onto the hand truck flap.

FIG. 10 illustrates an example of the multi-use platform in a fourth (work platform or scaffold) configuration.

FIG. 11 illustrates an example of a spring loaded pin lock for holding the legs of the multi-use platform in place located within the area C1 of FIG. 9.

FIG. 12 is a side view of an example of the multi-use platform in a fifth (workbench) configuration.

FIG. 13 illustrates an example of spring loaded push button for extending or retracting the legs of the multi-use platform.

FIG. 14 illustrates an example of a tapered peg that is opposite the spring loaded push button illustrated in FIG. 12.

FIG. 15 is a perspective view illustrating an example embodiment of a multi-use platform with a truss in the first configuration.

FIG. 16 is a side view illustrating an example embodiment of a multi-use platform with a truss.

FIG. 17 is a block diagram illustrating an example methodology for implementing a multi-use platform.

FIG. 18 is a perspective view illustrating an example of a second embodiment of a multi-use platform configured as a push cart.

FIG. 19 is a top view illustrating an example of the second embodiment of a multi-use platform configured as a work platform.

FIG. 20 is a side view illustrating an example of the second embodiment of a multi-use platform configured as a work platform.

FIG. 21 is a front view illustrating an example of the second embodiment of a multi-use platform with the rear wheels extended.

FIG. 22 is an exploded view illustrating an example of the second embodiment of a multi-use platform with a wheel extended within the area bounded by circle C in FIG. 19.

FIG. 23 is an exploded view of the frame of the second embodiment of the multi-use platform.

FIG. 24 is a perspective view illustrating an example of a first leg of the second embodiment of a multi-use platform.

FIG. 25 is a perspective view illustrating an example of the second leg of the second embodiment of the multi-use platform.

FIG. 26 is a perspective view illustrating an example of the bottom side of the second embodiment of a multi-use platform.

FIG. 27 is a perspective view illustrating an example of a third embodiment of a multi-use platform configured as a hand truck.

FIG. 28 is a perspective view illustrating an example of the third embodiment of a multi-use platform configured as a push cart.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

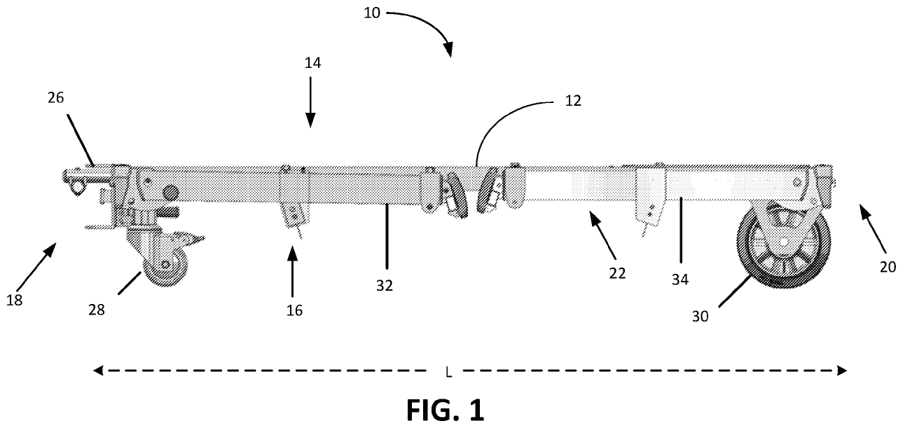

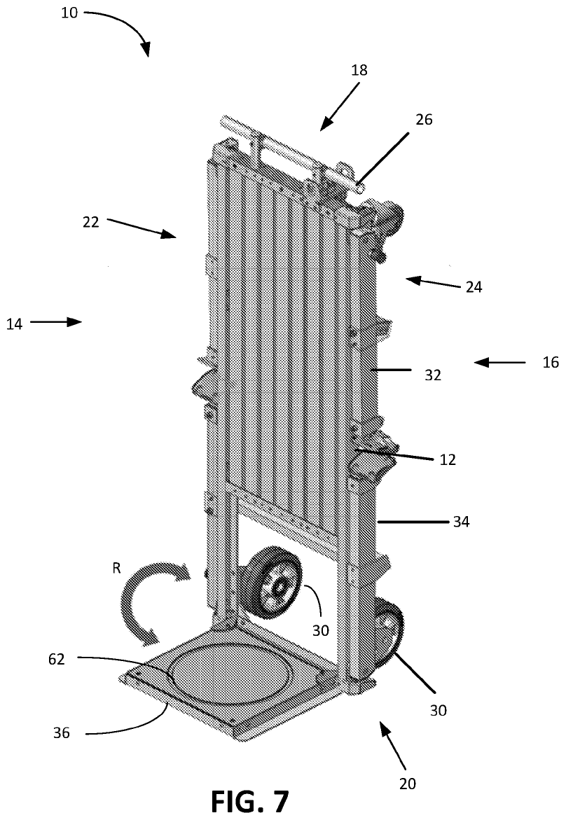

Referring to FIGS. 1-16 of the drawings, there is illustrated several example views of a multi-use platform 10. The multi-use platform 10 comprises a base 12. For ease of illustration, the base is described as having a top surface 14, bottom surface 16, a front side 18, a rear side 20, a right side 22 and a left side 24 with respect to the longitudinal axis L of the base 12.

A handle 26 is located near the front side 18 of the bottom surface 16 in several configurations. As will be described herein, infra, the handle 26 can be moved to different locations for different configurations.

The multi-use platform 10 further comprises a pair of front wheels 28 and rear wheels 30 located on the bottom surface 16 of the base. Although the front wheels 28 and rear wheels 30 are illustrated as having different sizes, those skilled in the art can readily appreciate that in other example embodiments the front wheels 28 and rear wheels 30 can be the same size.

A first pair of legs 32 are pivotably mounted on sides 22, 24 near the front side 18 of the base 12. A second pair of legs 34 are pivotably mounted on sides 22, 24 near the rear side 20 of the base 12. In an example embodiment, a bar 38 is coupled with the first pair of legs 32. In another example embodiment, a bar 40 is coupled with the second pair of legs 34. In still yet another example embodiment, bar 38 is coupled with the first pair of legs 32 and bar 40 is coupled with the second pair of legs 34.

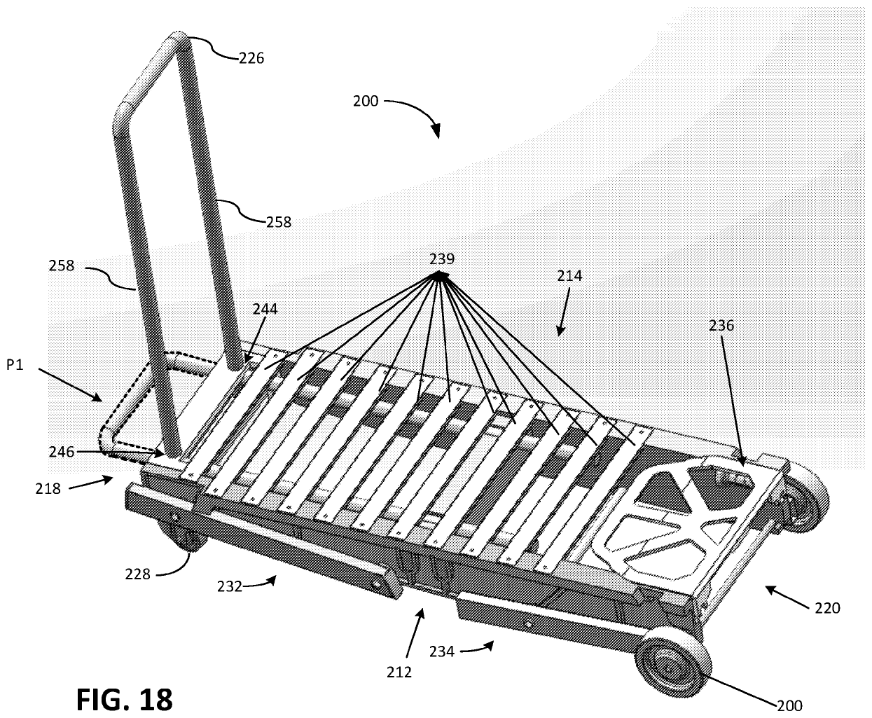

In the illustrated example, the top surface 14 comprises strips 37 extending from the front 18 of the base 12 to a bar 39 located in an area 41 that is adjacent to the hand truck flap 36. Those skilled in the art can readily appreciate the strips 39 can extend in other directions (see e.g., FIG. 18).

In an example embodiment, the base 12 comprises a hand truck flap 36 located adjacent to the rear side 20 of the top surface 14 is pivotably mounted to the base 12 and configured to rotate ninety degrees as will be described herein, infra.

In an example embodiment, located at the front side 18 of the top surface 14 of the base 12 a first tab 42 with an aperture 44 therein and a second tab 46 with an aperture 48 therein. In another example embodiment, there is located at the front side 18 of the bottom surface 16 of the base 12 a third tab 50 with an aperture 52 therein and a fourth tab 54 with an aperture 56 therein. In yet another example embodiment, there is located at the front side 18 of the top surface 14 of the base 12 a first tab 42 with an aperture 44 therein, and a second tab 46 with an aperture 48 therein, and there is located at the front side 18 of the bottom surface 16 of the base 12 a third tab 50 with an aperture 52 therein and a fourth tab 54 with an aperture 56 therein.

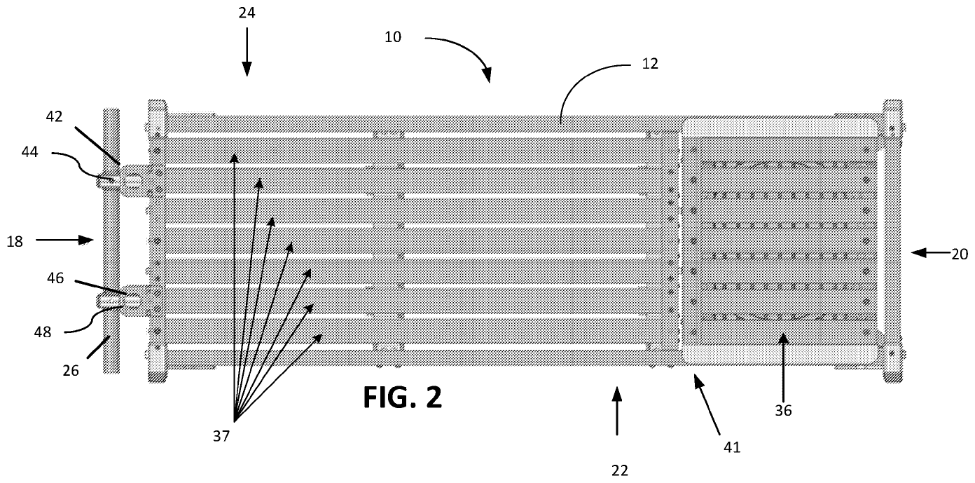

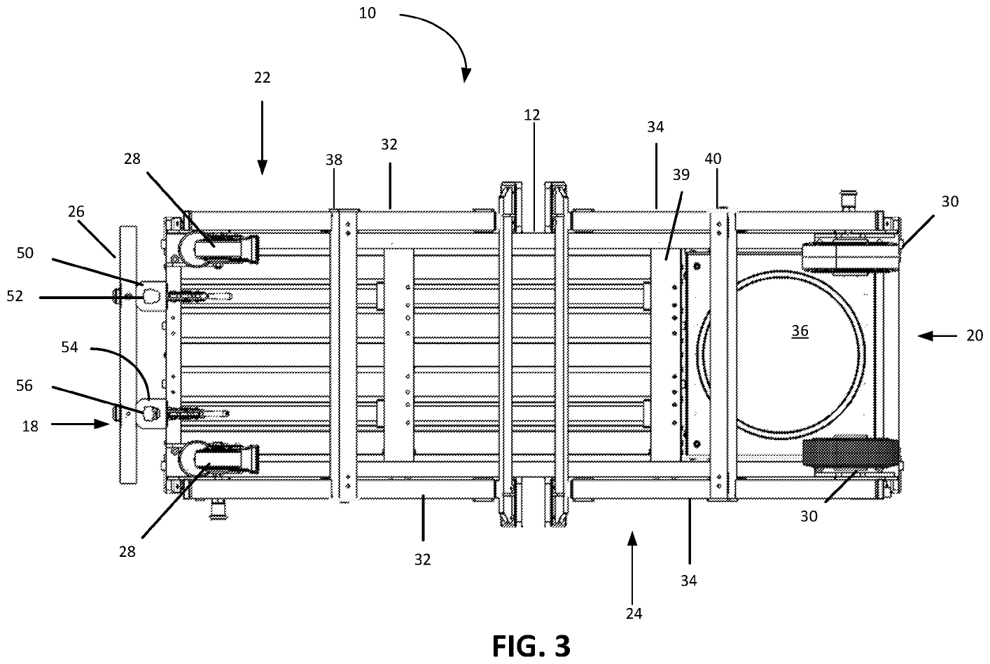

FIGS. 1-3 illustrate an example of the multi-use platform 10 in a first configuration. FIG. 1 illustrates an example of a side view of the multi-use platform in a first configuration. FIG. 2 illustrates an example of a top view of the multi-use platform in the first configuration. FIG. 3 illustrates an example of a bottom view of the multi-use platform in the first configuration.

In the first (or Mechanic's Creeper) configuration, the legs 32, 34 are underneath and substantially parallel to the base 12 along the bottom surface 16. The handle 26 is secured along the bottom surface 16 of the base 12. The legs being in the position illustrated in FIGS. 1-3 allows the wheels 28,30 to engage the surface (not shown) under the multi-use platform 10 and allows the multi-use platform 10 to roll along the surface. A feature of this configuration is that it takes up a minimal amount of space for storage, thus freeing up storage space for consumables at a job site.

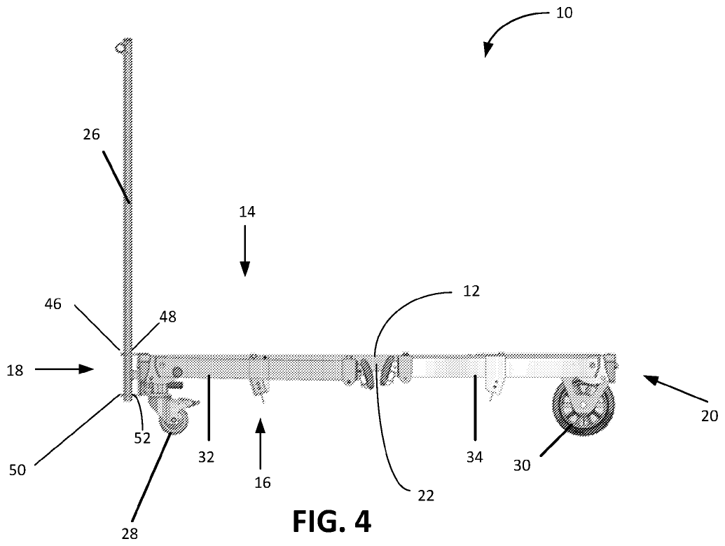

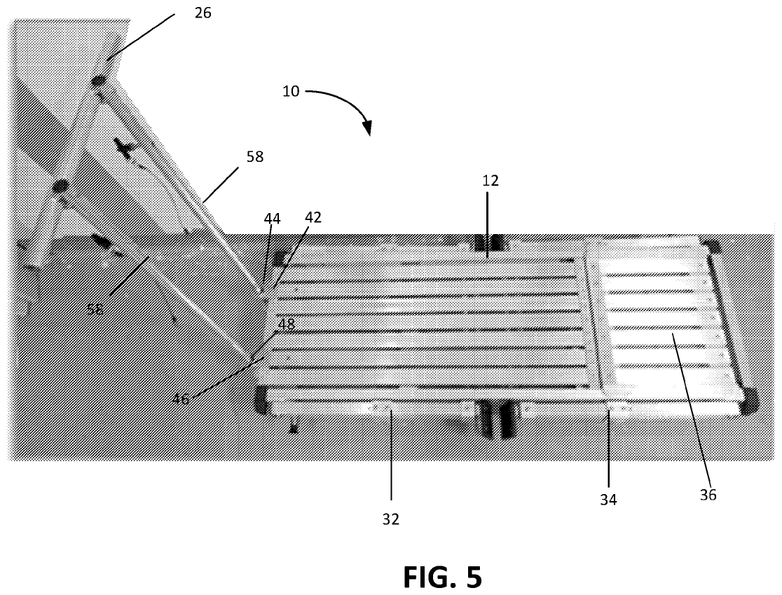

FIG. 4 illustrates an example side view of the multi-use platform 10 in a second (or pushcart) configuration. In the second configuration, the handle 26 is removed from under the base 10 and the arms 58 of the handle 26 are inserted into the apertures 44, 48, 52, 56 of tabs 42, 46, 50, 54 respectively. FIG. 5 is a perspective view of the multi-use platform in the second configuration.

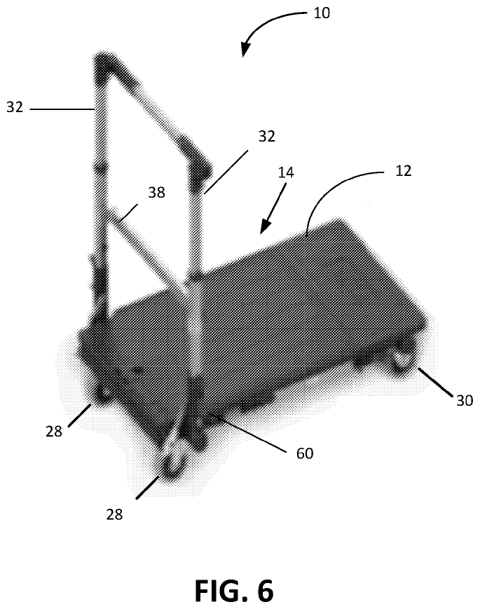

FIG. 6 illustrates a perspective view of an alternative embodiment of the multi-use platform 10 in the second configuration. In the second configuration, legs 32 are rotated until they are substantially perpendicular with the top surface 14 of the base 12. In an example embodiment, a locking mechanism 60, such as a spring loaded pin, is employed to lock the legs 32 in place. In particular embodiments, the legs 32 are telescopic, and their length can be extended.

In an example embodiment, the hand truck flap further comprises a recessed ring 62. In particular embodiments, the recessed ring 62 is sized to hold a five gallon paint bucket.

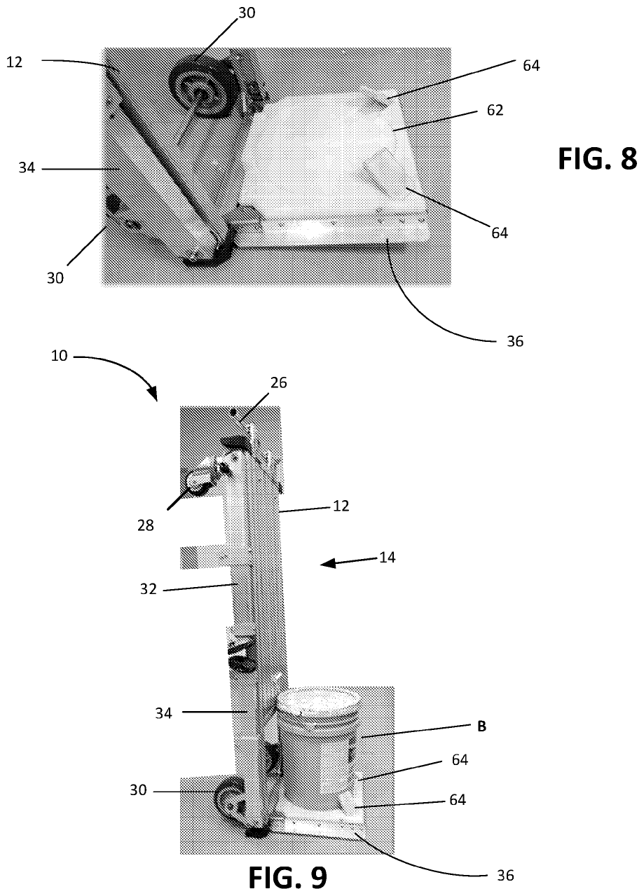

In an example embodiment, the hand truck flap 36 further comprises grips 64 as illustrated in FIG. 8, which is a close up view illustrating an example of grips 64 on the hand truck flap 36. In particular embodiments, the grips 64 are spring loaded and will automatically moved to the position illustrated in FIGS. 8-9 when the hand truck flap 36 is rotated away from the base 12.

FIG. 9 is a perspective view illustrating the third configuration of the multi-use platform 10 with a five gallon paint bucket B surmounted onto the hand truck flap 36 In the illustrated example, the grips 64 are employed to hold the five gallon paint bucket B in place.

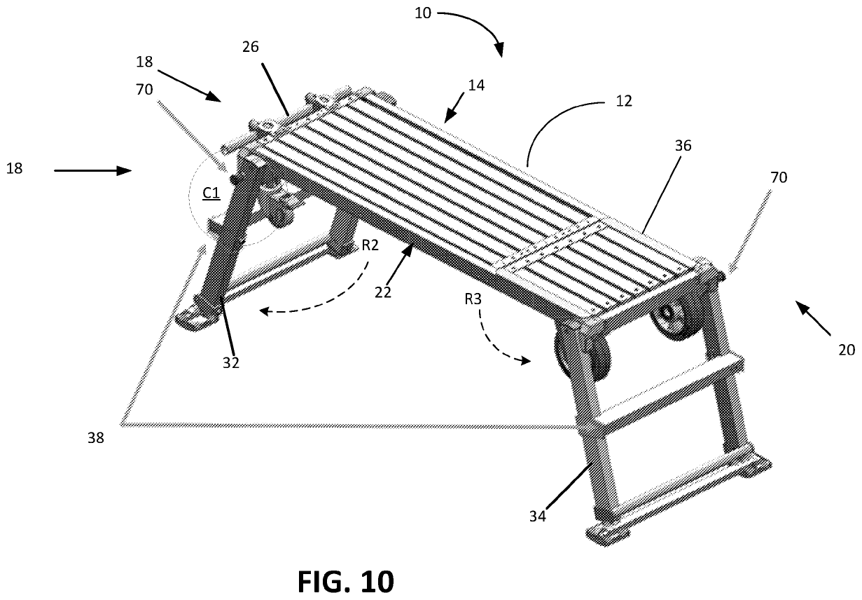

FIG. 10 illustrates an example of the multi-use platform 10 in a fourth (work platform or scaffold) configuration. In this configuration legs 32 are rotated in direction R2 away from the base 12 and legs 34 are rotated in direction R3 away from the base 12. In the illustrated example, the handle 26 remains stored under the base 12, however, as those skilled in the art can readily appreciate, the handle 26 can be repositioned as illustrated in FIG. 4 and function as a railing. Bars 38 can function as steps. A user can walk on the top surface 14 of the base 12 for performing tasks, such as, for example, painting hard to reach areas near the top of a wall.

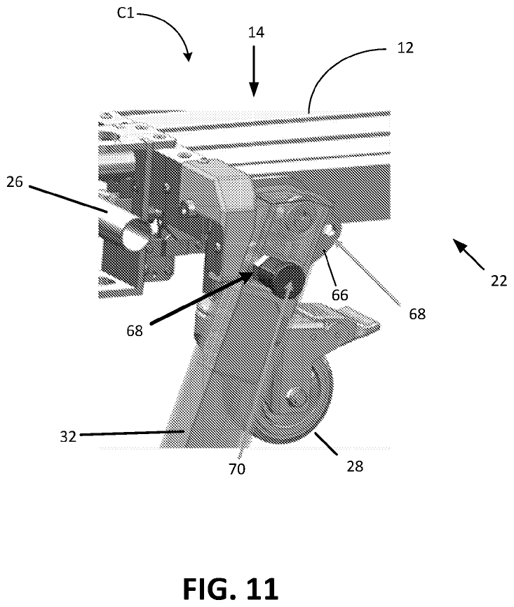

FIG. 11 illustrates an example of a spring loaded pin lock 70 for holding the legs 32 of the multi-use platform 10 in place located within the area C1 of FIG. 9. A bracket 66 is mounted onto the side 22 of base 12. The bracket 66 comprises holes 68 for holding the legs 32 in a desired position. The spring loaded pin lock 70 passes through legs 32 and into a hole 68 and holds the legs 32 in place. Pulling on the spring loaded pin lock 70 allows the legs 32 to move (rotate) from one position to another.

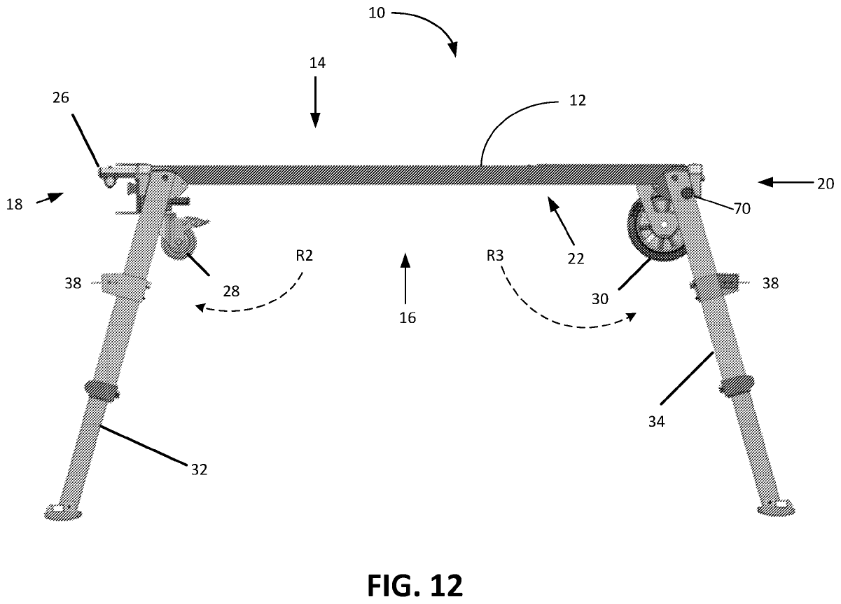

FIG. 12 is a side view of an example of the multi-use platform 10 in a fifth (workbench) configuration. Like the work platform configuration, legs 32 are rotated in direction R2 away from the base 12 and legs 34 are rotated in direction R3 away from the base 12. As will be described herein, the legs 32, 34 are telescopically extended, In an example embodiment, the height of the workbench can be adjusted by adjusting the lengths of the legs 32, 34.

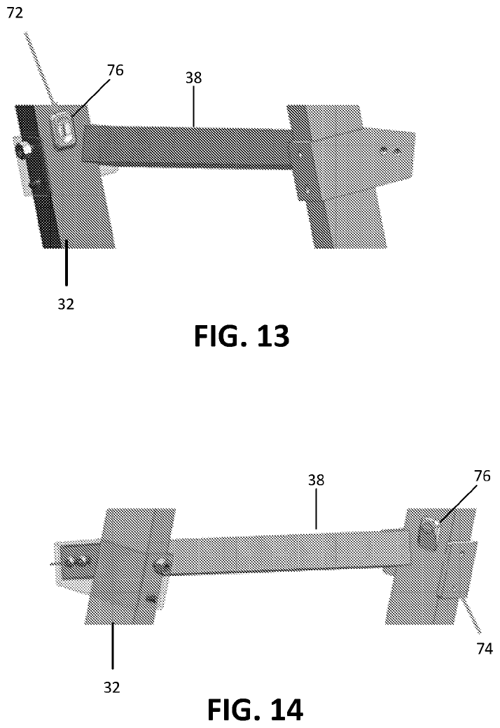

FIG. 13 illustrates an example of spring loaded push button 72 for extending or retracting the legs 32 of the multi-use platform 10. Pushing the spring loaded push button 72 in allows for a section of the legs 32 to slide until the spring loaded push button 72 encounters another hole 76 in the legs 32.

FIG. 14 illustrates an example of a tapered peg 74 that is opposite the spring loaded push button 72 illustrated in FIG. 12. The tapered peg 74 allows for one-handed extension or retraction of the legs 32 and locks into corresponding holes 76 in the legs 32. Legs 34 can be extended or retracted in a similar manner.

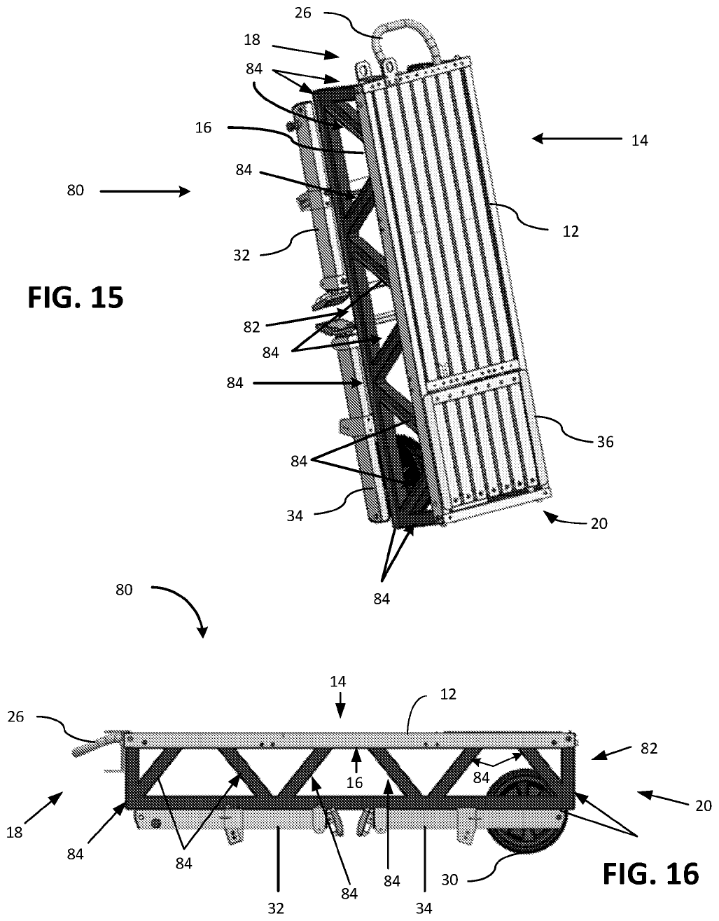

FIGS. 15 and 16 illustrate an example of an alternate embodiment 80 of a multi-use platform where a truss 82 formed by members 84 is located between bottom surface 16 of the base 12 and legs 32, 34. FIG. 15 illustrates a perspective view of the multi-use platform 80 with a truss 82 and FIG. 16 illustrates a side view of the multi-use platform 80 with a truss 82. A feature of the truss 82 is that it can reduce the length of the legs 32, 34. In particular embodiments, truss 82 can be formed of plastics or composites while the legs 32, 34 are formed of a metal, such as for example, aluminum. This can reduce the amount of aluminum used in the multi-use platform. Shorter legs 32, 34 can result in a more rigid platform.

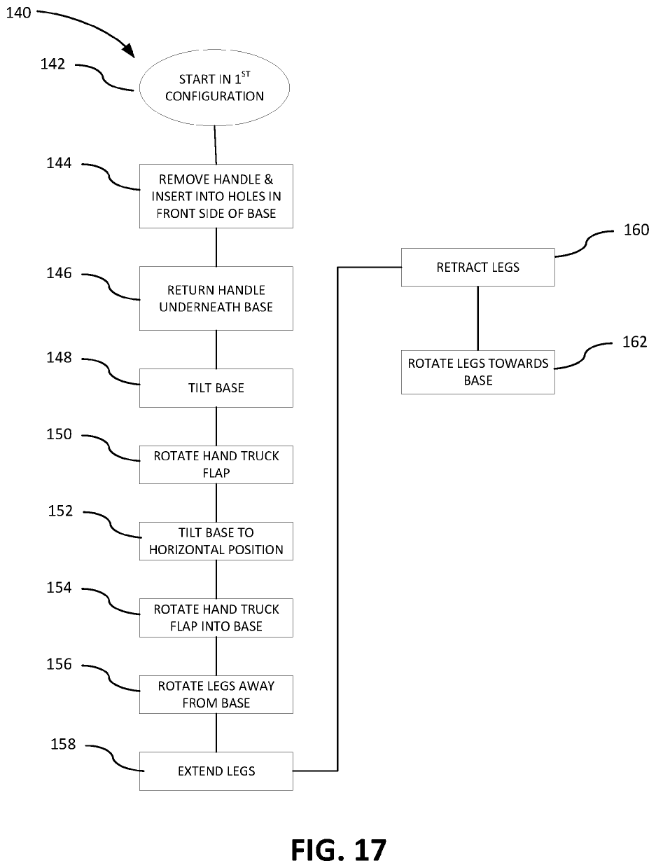

In view of the foregoing structural and functional features described above, a methodology 140 in accordance with an example embodiment will be better appreciated with reference to FIG. 17. While, for purposes of simplicity of explanation, the methodology 140 of FIG. 17 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement an example embodiment.

Methodology 140 illustrates the acts involved to change the multi-use platform 10 into various configurations. Methodology 140 illustrates the acts for changing from the first (mechanical creeper) configuration to the second (pushcart) configuration to the third (hand truck) configuration, the fourth (work platform) configuration, and the fifth (workbench) configuration. As those skilled in the art can readily appreciate, the multi-use platform can be configured in any order (for example from the first configuration to the fourth configuration) and thus many of the acts illustrated herein can be skipped.

In this example, the multi-use platform 10 is in the first configuration at 142. In this configuration, the legs 32, 4 are along the sides 22, 24 of the base 12 and the handle is stored under the base 12.

At 144, the multi-use platform 10 is changed to the second (pushcart) configuration. The handle 26 is removed from underneath the base and is inserted into the apertures 44, 48, 52, 56 of tabs 42, 46, 50, 54 respectively. In an alternate embodiment, the legs 32 which are pivotally coupled with the front surface 18 of the base, are rotated two hundred and seventy degrees or until the legs 32 are substantially perpendicular with the top surface 14 of the base 12.

At 146, the multi-use platform is changed from the second configuration to the first configuration. The handle 26 is removed from the apertures 44, 48, 52, 56 of tabs 42, 46, 50, 54 respectively and stored underneath the base 12. In the alternative embodiment, the legs 32 are rotated two hundred seventy degrees or until they are parallel with the base 12.

As will be illustrated in 148 and 150, the multi-use platform is changed from the first configuration to the third (hand truck) configuration. At 148, the base 12 is tilted so it that wheels 50 are engaging the bottom surface and wheels 28 are not. In an example embodiment, the base 12 is rotated substantially (e.g., within thirty degrees) perpendicular of the bottom surface.

At 150, the hand truck flap 36 is rotated away from the base 12. In an example embodiment, the hand truck flap 36 is rotated ninety degrees (or is perpendicular to) the base 12. In particular embodiments, the hand truck flaps 36 comprise grips 64. In at least one example embodiment, the grips 64 are spring loaded and automatically deploy when the hand truck flap 36 rotates away from the base 12.

As will be illustrated at 152, 154, the multi-use platform is returned from the hand truck configuration to the first configuration. At 152, the base 12 is rotated until the base is substantially horizontal (e.g., as illustrated in FIG. 1) the wheels 28, 30 engage the surface (e.g., floor or ground) under the base 12. At 154, the hand truck flap 36 is rotated into (or parallel and in alignment with) the base 12.

The multi-use platform 10 can be changed from the first configuration to the fourth (work platform) configuration as will be illustrated at 156. At 156, legs 32 are rotated in direction R2 and legs 34 are rotated in direction R3. In an example embodiment, spring loaded pin locks 70 are employed to lock the legs 32, 34 in place.

From the fourth configuration, the multi-use platform 10 can be changed to the fifth (work bench) configuration. After the legs 32, 34 have been rotated as described at 156, the legs 32, 34 are telescopically extended as illustrated at 158. In an example embodiment, a spring loaded push button 72 is pushed and a section of the legs can slide over the spring loaded push button 72 and a tapered peg 74 that is opposite the spring loaded push button 72 until engaging the next hole in the legs (either legs 32 or legs 34).

At 160, multi-use platform 10 is changed from the fifth configuration to the fourth configuration. The legs 32, 34 are telescopically retracted. In an example embodiment, a spring loaded push button 72 is pushed and a section of the legs 32, 34 can slide over the spring loaded push button 72 and a tapered peg 74 that is opposite the spring loaded push button 72 until engaging the next hole in the legs 32, 34.

At 162, multi-use platform 10 is changed from the fourth configuration to the first configuration. Legs 32 or rotated in a direction opposite R2 and in an example embodiment until along (e.g. parallel with) the sides 22, 24 of the base 12. Legs 34 or rotated in a direction opposite R3 and in an example embodiment until along (e.g. parallel with) the sides 22, 24 of the base 12.

The first configuration is the most compact configuration. Thus, the first configuration can also be suitable for storage of the multi-use platform 10.

Referring to FIGS. 18-26 there is illustrated a second embodiment of a multi-use platform 200. The multi-use platform 200 comprises a base 212. For ease of illustration, the base is described as having a top surface 214, bottom surface 216, a front side 218, a rear side 220, a right side 222 and a left side 224 with respect to the longitudinal axis of the base 212.

A handle 226 is located near the front side 218 of the bottom surface 216 in several configurations. As will be described herein, infra, the handle 226 can be moved to different locations for different configurations.

The multi-use platform 200 further comprises a pair of front wheels 228 and rear wheels 230 located on the bottom surface 216 of the base. Although the front wheels 228 and rear wheels 230 are illustrated as having different sizes, those skilled in the art can readily appreciate that in other example embodiments the front wheels 228 and rear wheels 230 can be the same size.

A first pair of legs 232 are pivotably mounted on sides 222, 224 near the front side 218 of the base 212. A second pair of legs 234 are pivotably mounted on sides 222, 224 near the rear side 220 of the base 212. In an example embodiment, a bar 238 is coupled with the first pair of legs 232. In another example embodiment, a bar 240 is coupled with the second pair of legs 234. In an example embodiment, bars 238, 240 can also function as a step in the fourth (work platform or scaffold) configuration.

FIG. 18 illustrates an example perspective view of the multi-use platform 200 in the second (or pushcart) configuration. In the second configuration, the handle 26 is removed from under the base 210 (position P1) and the arms 258 of the handle 226 are inserted into the apertures 246, 248 In the illustrated example, strips 239 are located on the top 214 of the base 212 and extend between the right 222 and left 224 sides of the base 212, however, as those skilled in the art can readily appreciate the strips 239 can be arranged in any desired configuration (see e.g., strips 37 in FIG. 2).

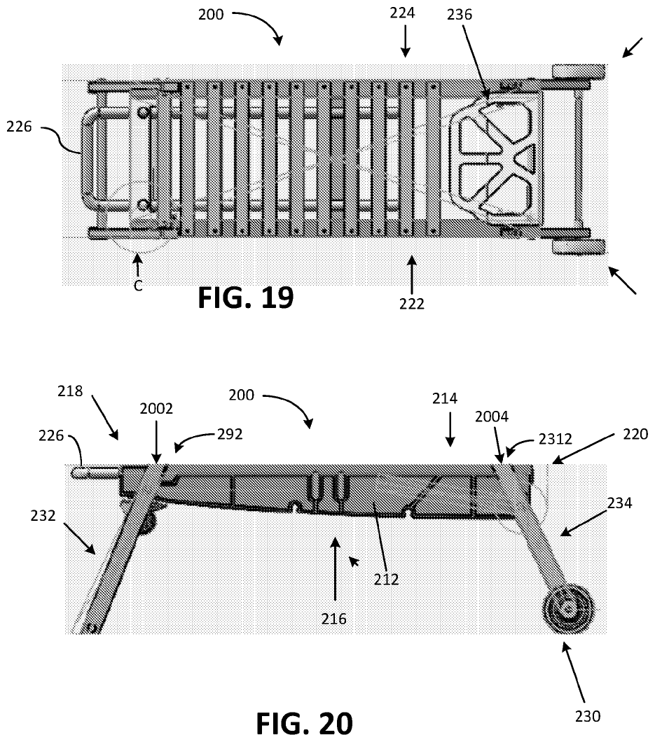

FIG. 19 is a top view illustrating an example of the second embodiment of a multi-use platform 200 configured as a work platform (fourth configuration). FIG. 22 illustrates an exploded view of the area bounded by circle C.

FIG. 20 is a side view illustrating an example of the second embodiment of a multi-use platform 200 configured as a work platform. As will be described in further detail herein, bar 2408 of leg 232 engages a cutout 2310 at the front end 218 of the base 212 and the end of the leg 2002 rests against edge 292 holding leg 232 in place. End 2004 of leg 234 fits into slot 2312 and bar 240 of leg 234 engages a cutout 2310 at the rear end 220 of the base 212 to hold leg 234 in place.

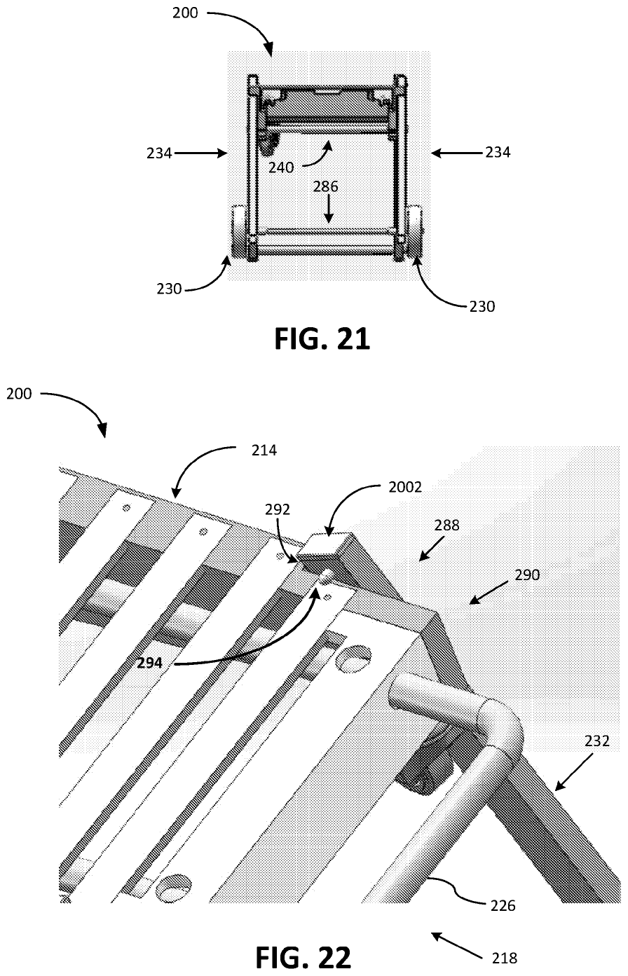

FIG. 21 is a front view illustrating an example of the second embodiment of a multi-use platform 200 with the rear wheels 230 extended. This view illustrates bar 240 extending between the right 222 and left 224 sides of the base 212 and axle 286 upon which wheels 230 are surmounted.

FIG. 22 is an exploded view illustrating an example of the second embodiment of a multi-use platform with a wheel extended within the area bounded by circle C in FIG. 19. A notch 290 is formed in the corner 290. The end 2002 of leg 232 rests against the edge 292 of the notch 288 in this configuration. In particular embodiments, the leg 232 comprises a nub 294 that rests on the top surface 214 of the base 202, which can provide further stability to leg 232.

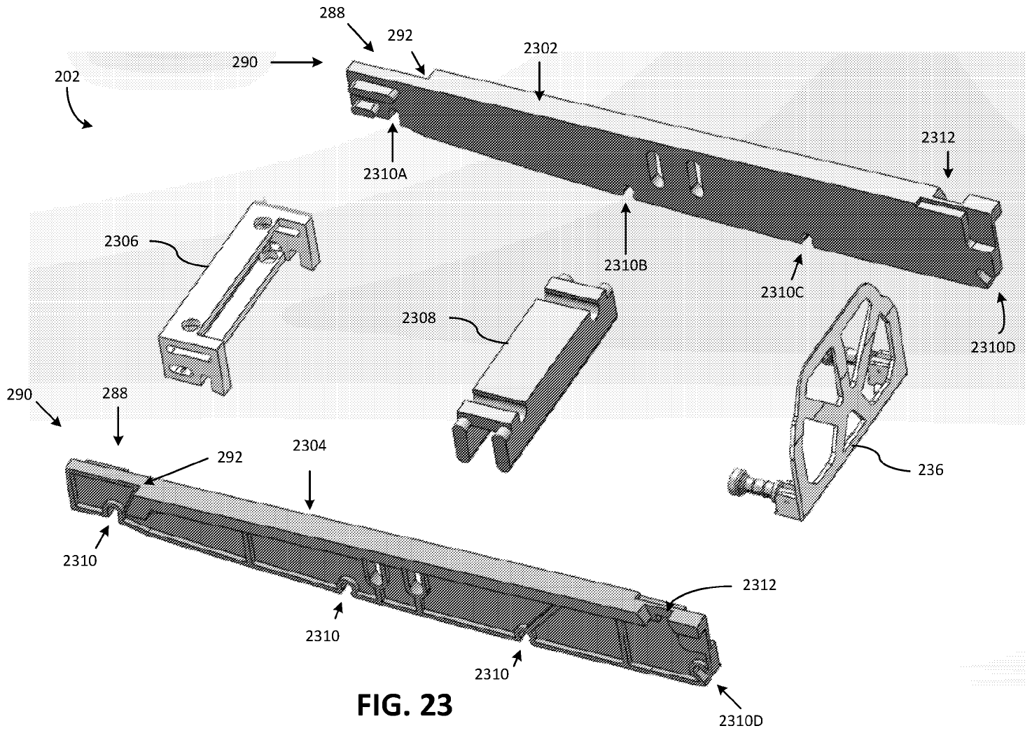

FIG. 23 is a an exploded view of the base 202 of the second embodiment of the multi-use platform 200. The base comprises a first rail 2302 and a second rail 2304 that are couple together by a first cross member 2306 and a second cross member 2308. In an example embodiment, the rials 2302, 23404 and cross members 2306, 2308 have tabs and apertures that are configured to mate the rails 2302, 2304 with the cross members 2306, 2308. The hand truck flap is rotatably attached to the rails 2302, 2304. Edges 292 of notches 288 are configured to support legs 232 when the legs 232 are extended away from the base 212. Slots 2312 supports legs 234 when the legs 234 are in the extended position. Cut outs 2310 are configured to hold the bars 238, 2408 of legs 232, and bar 240 and axle 286 of legs 234.

In an example embodiment, when the legs 232, 234 are retracted, for example in the first (or mechanical creeper) configuration, bar 238 engages cutout 2310A, bar 2408 engages bar 2310B, bar 240 engages cutout 2310C, and axle 286 engages cutout 2310D. When leg 232 is in the extended position, bar 2238 engages cutout 2310A and ends 2002 rest along the edges 292. When the leg 234 is in the extended position, the bar 240 engages cutout 2310D and the ends 2502 fit into slots 2312.

In the first (or Mechanic's Creeper) configuration, the legs 32, 34 are underneath and substantially parallel to the base 12 along the bottom surface 16. The handle 26 is secured along the bottom surface 16 of the base 12.

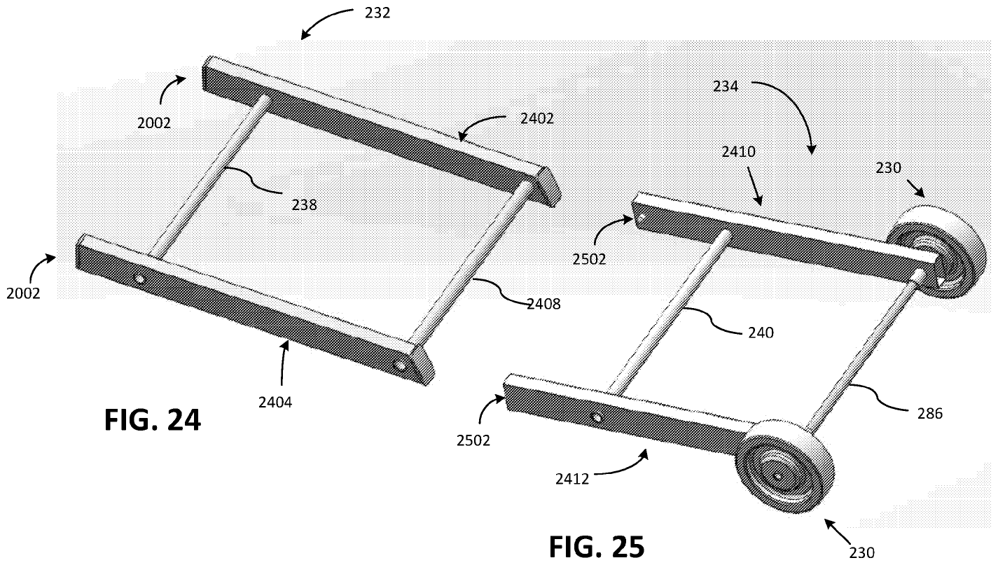

FIG. 24 is a perspective view illustrating an example of a first leg 232 of the second embodiment of a multi-use platform 200. FIG. 25 is a perspective view illustrating an example of the second leg of the second embodiment of the multi-use platform 200.

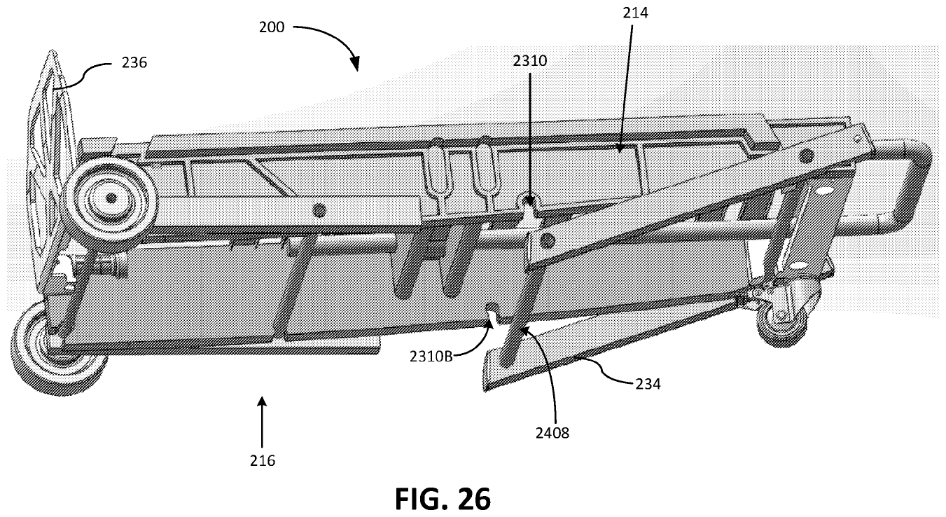

FIG. 26 is a perspective illustrating an example of the bottom side 216 of the second embodiment of a multi-use platform 200 from the left side 214 in the third (or hand truck) configuration. In the illustrated example, hand truck flap 236 is rotated away from the base 212. Axle 286 and bar 240 are engaged with cutouts 2310D and 2310C respectively. Bar 238 is engaged with cutout 2310A and bar 2408 is adjacent cutout 2310B.

In an example embodiment, the first configuration (mechanical creeper) is achieved when 232, 234 are parallel with the base 202, where bar 238 and 2408 of leg 232 engage cutouts 2310A and 2310B respectively, and bar 240 and axle 286 engage cutouts 2310C and 2310D respectively. Hand truck flap 236 is rotated to be parallel with the base 202.

For the second configuration (push cart), bar 238 and 2408 of leg 232 engage cutouts 2310A and 2310B respectively, and bar 240 and axle 286 engage cutouts 2310C and 2310D respectively. The handle 236 is removed from position P1 and arms 258 are inserted into apertures 244, 246 as illustrated in FIG. 18.

For the third configuration (hand cart), the base 202 is rotated along axle 286. The hand truck flap 236 is rotated away from the base 212 as illustrated in FIG. 26. Bar 238 and 2408 of leg 232 engage cutouts 2310A and 2310B respectively, and bar 240 and axle 286 engage cutouts 2310C and 2310D respectively.

For the fourth configuration (work platform or scaffold), the legs 232 and 234 are in the extended position. The bar 2238 engages cutout 2310A and ends 2002 rest along the edges 292. The bar 240 engages cutout 2310D and the ends 2502 fit into slots 2312. In an example embodiment, the hand truck flag 236 is parallel with the base 202. An example of this configuration is illustrated in FIG. 20.

For the fifth configuration (work bench), legs 232, 234 are telescopically extended (not shown, see e.g., FIG. 12). The legs 232 and 234 are in the extended position. The bar 2238 engages cutout 2310A and ends 2002 rest along the edges 292. The bar 240 engages cutout 2310D and the ends 2502 fit into slots 2312. In an example embodiment, the hand truck flag 236 is parallel with the base 202.

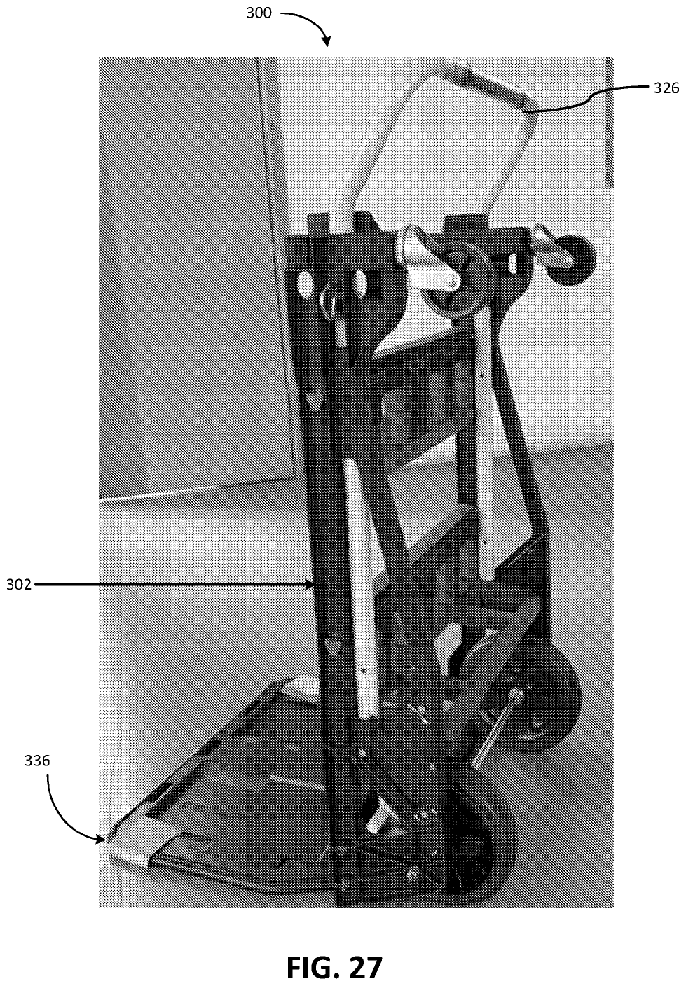

FIG. 27 is a perspective view illustrating an example of a third embodiment of a multi-use platform 300 configured as a hand truck. The flap 326 is rotated away from the base 302. The handle 326 are positioned underneath the base 302. In this example, the handle 32 is curved.

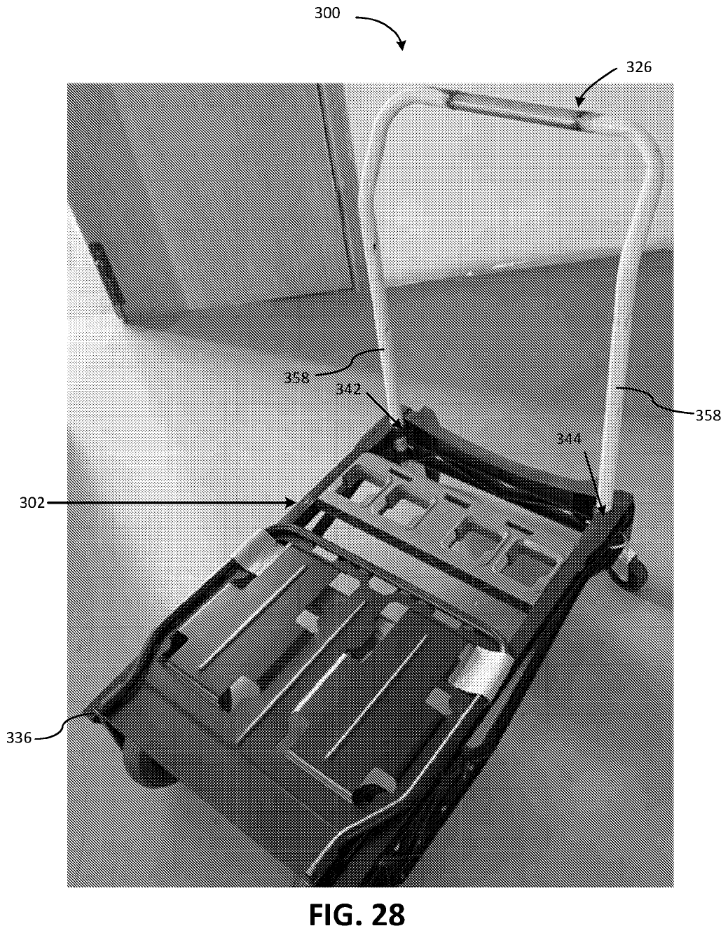

FIG. 28 is a perspective view illustrating an example of the third embodiment of a multi-use platform 300 configured as a push cart. The arms 358 handle 326 are inserted into apertures 342, 344 of base 302. The hand truck flap 326 is parallel with the base 302.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
a base, the base comprises a top, bottom, front, rear, left, and right surfaces;
a first pair of legs pivotably coupled with the base at the front end, the first pair of legs are operable to telescopically extend from a retracted position to an extended position;
a second pair of legs pivotably coupled with the base at the rear end, the second pair of legs are operable to telescopically extend from a retracted position to an extended position;
a handle operable to move between a first position on the bottom surface of the base and a second position on the top surface of the base;
a plurality of strips on the top surface of the base;
a hand truck flap rotatably coupled at the rear side of the base, the hand truck flap is pivotably coupled with the base;
a first pair of wheels coupled with the front of the base; and
a second pair of wheels coupled with the rear of the base.

2. The apparatus set forth in claim 1, comprising a first configuration where:
the first pair of legs are parallel with the base;
the second pair of legs are parallel with the base the handle is in the first position;

3. The apparatus set forth n claim 2, comprising a second configuration where:
the handle is positioned on top of the base;
the first pair of legs are parallel with the base; and
the second pair of legs are parallel with the base/

4. The apparatus set forth in claim 3, comprising a third configuration where:
the handle is positioned on top of the base;
the first pair of legs are parallel with the base;
the second pair of legs are parallel with the base; and
the hand truck flap extends away from the base.

5. The apparatus set forth in claim 4 wherein the hand truck flap is perpendicular to the base.

6. The apparatus set forth in claim 4, comprising a fourth configuration where:
the handle is positioned on top of the base;
the first pair of legs extend away from the base; and
the second pair of legs extend away from the base.

7. The apparatus set forth in claim 6, comprising a fifth configuration where:
the handle is positioned on top of the base;
the first pair of legs extend away from the base and are telescopically extended; and
the second pair of legs extend away from the base and are telescopically extended.

8. The apparatus set forth in claim 1, wherein the rear wheels are larger in diameter than the front wheels.

9. The apparatus set forth in claim 1, wherein the hand truck flap comprises a ring sized to fit a five gallon paint bucket.

10. The apparatus set forth in claim 9, the hand truck flap further comprises grips that are spring loaded and configure to extend when the hand truck flap rotates away from the base and retract when the hand truck flap rotates toward the base.

11. The apparatus set forth in claim 1,
the first pair of leg further comprises a bar extending between the first pair of legs and operable to function as a step when the first pair of legs are rotated away from the base; and
the second pair of leg further comprises a bar extending between the second pair of legs and operable to function as a step when the second pair of legs are rotated away from the base

12. The apparatus set forth in claim 1, further comprising spring pin locks configured to hold the first pair of legs in a first position

13. The apparatus set forth in claim 1, further comprising:
a spring loaded push button for extending or retracting the first pair of legs;
pushing the spring loaded push button allows for a section of the first pair of legs 32 to slide until the spring loaded push button encounters another hole in the first air of legs.

14. The apparatus set forth in claim 1, further comprising a truss having a top side coupled with the bottom surface of the base, and a bottom side coupled with the first pair of legs and the second pair of legs.

15. An apparatus, comprising:
a base, the base comprises first and second rails having a top surface and a bottom surface with notches and slots on the top surface and cutouts on the bottom surface;
a first pair of legs that comprise a first bar and a second bar coupled with the legs and are configured to engage first and second cutouts of the first and second rails respectively when in a first position, and the first bar is configured to engage the first cutouts of the first and second rails and an end of the first pair of legs is configured to engage the notches on the top of the first and second rails when in a second position;
a second pair of legs that comprise a bar and an axle coupled with the pair of legs and configured to engage third and fourth cutouts of the first and second rails respectively when in a first position, and the second leg's bar is configured to engage the fourth cutouts of the first and second rails and an end of the second pair of legs is configured to engage the slots on the top of the first and second rails when in a second position;
the second pair of legs further comprise a first pair wheels mounted on the axle;
a second pair of wheels coupled with the bottom of the base at a rear side of the base;
a hand truck flap coupled with the base at the front side of the base, the hand truck flap is configured to rotate between a first position that is parallel with the base and a second position that is perpendicular to the base; and
a handle configured to mount under the base in a first configuration and on top of the base in a second configuration.

16. The apparatus set forth in claim 15, wherein the first pair of wheels have a larger diameter than the second pair of wheels.

17. The apparatus set forth in claim 15, further comprising a first predefined configuration where:
the handle is mounted on top of the base;
first pair of legs engages the first and second cutouts of the rails; and
the second pair of legs engages the third and fourth cutouts of the rails.

18. The apparatus set forth in claim 17, further comprising a second predefined configuration where:
the handle is mounted underneath the base;
first pair of legs engages the first and second cutouts of the rails;
the second pair of legs engages the third and fourth cutouts of the rails; and
the hand truck flap is parallel with the base.

19. The apparatus set forth in claim 17, further comprising a third predefined configuration where:
the handle is mounted underneath the base;
first pair of legs engages the first cutouts and the notches of the rails; and
the second pair of legs engages the third cutouts and slots of the rails.

20. The apparatus set forth in claim 17, further comprising a second predefined configuration where:
the handle is mounted underneath the base;
first pair of legs engages the first and second cutouts of the rails; and
the second pair of legs engages the third and fourth cutouts of the rails; and
the hand truck flap is perpendicular to the base.
